(19) United States
(12) Patent Application Publication
(10) Pub. No.: US 2020/0094240 A1
(43) Pub. Date: Mar. 26, 2020

(54) THREE DIMENSIONAL METAL SULFIDES CATALYTIC STRUCTURES, METHODS OF MAKING AND USES THEREOF

(71) Applicant: SABIC Global Technologies B.V., Bergen op Zoom (NL)

(72) Inventors: Gregory BIAUSQUE, Thuwal (SA); Lawrence D'SOUZA, Thuwal (SA); Sivadinarayana CHINTA, Thuwal (SA)

(21) Appl. No.: 16/468,727

(22) PCT Filed: Dec. 8, 2017
(86) PCT No.: PCT/IB2017/057753

§ 371 Date: Jun. 12, 2019

Related U.S. Application Data
(60) Provisional application No. 62/434,737, filed on Dec. 15, 2016.

(51) Int. Cl. B01J 37/20; B01J 37/10; B01J 23/06; B01J 35/04; B01J 35/10; B01J 35/02; B01J 35/08; C01B 32/40; C01B 17/50

(52) U.S. Cl. CPC B01J 37/20; B01J 37/10; B01J 23/06; B01J 35/04; B01J 35/1009; C01B 17/50; B01J 35/1076; B01J 35/026; B01J 35/08; C01B 32/40; B01J 35/1014

(57) ABSTRACT

A bulk three-dimensional (3-D) catalyst and methods of making and use are described herein. The bulk three-dimensional (3-D) catalyst is formed from a catalytically active metal or metal alloy and has a sulfurized or oxidized outer surface.

### CROSS REFERENCE TO RELATED APPLICATIONS

This application claims the benefit of priority of U.S. Provisional Patent Application No. 62/434,737 filed Dec. 15, 2016, which is hereby incorporated by reference in its entirety.

### BACKGROUND OF THE INVENTION

### A. Field of the Invention

The invention generally concerns a bulk three-dimensional (3-D) catalyst formed from a catalytically active metal or metal alloy and having a sulfurized or oxidized outer surface. The catalyst can be used in high temperature heterogeneous catalysis reactions (e.g., 800 ° C. to 1500 ° C.).

### B. Description of Related Art

Conventional heterogeneous catalysts can include active metals supported on inert or acidic/basic support materials possessing a 3-D structure. These catalysts can be prepared by extrusion or pelletizing, and are often highly dense in order to provide good mechanical strength. One of the drawbacks of using highly dense 3-D support materials is that the bulk of the catalyst (i.e., the support) is not accessible, consequently not catalytic. Moreover, at high temperatures a loss in mechanical strength of the support material can occur, thereby resulting in the increased production of fine powder. By way of example, in high temperature heterogeneous catalysis applications (e.g., >600° C.), the active metal, metal oxide supports, and metal sulfide supports can undergo sintering. Sintering can result in a decrease in active surface area and catalytic activity. Sintering can also lead to catalyst attrition, followed by powder formation, and, in some cases, breakage of pellets and extrudates can take place, resulting in more powder formation. The resulting powder can accumulate in the reactor, affecting downstream processes and/or decrease reactor pressure.

One attempt to overcome reaction pressure drop includes the introduction of ceramic monoliths to the reactor, especially in selective catalytic reduction (SCR) catalysts for mobile applications. However, industrial ceramic monoliths can possess poor mechanical strength and are difficult to apply in larger installations for immobile applications. Moreover, ceramic monoliths may not be suitable for high temperature applications.

Other attempts involve making catalytically inert metallic monoliths having catalytically active metal species coated on the inert metallic monolith surface. By way of example, U.S. Pat. No. 4,912,077 to Irwin et al., describes a unitary composite structure consisting essentially of sintered catalytically active precious metal and/or a base metal coated on a supporting inert structural metal. In another example, U.S. Pat. No. 7,166,323 to Shik et al., describes a metal monolithic catalyst that includes partially sintered metal coated on an electrical conductive inert metal support. In yet another example, Li et al., (“In situ synthesis of 3D flower-like NiMnFe mixed oxides as monolith catalysts for selective catalytic reduction of NO with NH₃”, Chem. Commun., 2012, (48), pp. 10645-10647) describes a 3-D flower-like NiMnFe mixed oxide grown on inert iron meshes that are useful for catalytic reduction of NO with NH₃ at temperatures of 500° C. or less.

Despite all of the currently available research focused on the development of heterogeneous catalysts, many of these catalysts include an inert ceramic or metal support and/or are not suitable for high temperature reactions.

### SUMMARY OF THE INVENTION

A solution to the problems associated with heterogeneous catalysts used for high temperature applications has been discovered. The solution resides in the ability to prepare a catalytically active metal or metal alloy three-dimensional (3-D) structure having a sulfurized or oxidized outer surface, where the catalytically active metal or metal alloy forms the 3-D structure. Notably, the current invention overcomes the issue of using an inert or unreactive support by forming the 3-D structure from catalytic active metal(s). The 3-D structure can be treated in situ to form metal sulfide and/or metal oxide layers on the structure. The in situ surface treatment process provides control over the thickness of oxide or sulfide layers. The resulting catalysts of the present invention are particularly suitable for high temperature reactions such as at temperatures from 800° C. to 1500° C. Further, the catalytically active 3-D structure are expected to possess relatively high mechanical strength when compared with traditional inert (not reactive in a catalytic reaction) support materials. Therefore, the catalysts of the present invention are expected to be more resistant to attrition and/or sintering than similar catalysts with conventional non-reactive supports, thereby reducing or avoiding the potential of pressure drop during the reaction.

In one particular embodiment, a bulk three-dimensional (3-D) catalyst is described. The bulk three-dimensional (3-D) catalyst can include a catalytically active metal or metal alloy 3-D structure having a sulfidized or oxidized outer surface. The catalytically active metal or metal alloy forms the 3-D structure. In a preferred embodiment, 3-D structured catalyst consists essentially of the catalytically active metal or metal alloy having a sulfurized or oxidized outer surface. The 3-D structured catalyst can have layers of sulfurized or oxidized catalytic metal or metal alloy including the sulfurized or oxidized outer layer. By way of example, the 3-D structured catalyst can have 1 to 10 layers between the surface layer and the catalytic metal. Such layers can inhibit decomposition of the catalytic metal. In one aspect, the catalytic metal or metal alloy can include an alkaline earth metal, a transition metal, a post-transition metal, any combination thereof, or any alloy thereof. In another aspect, the catalytically active metal can be nickel (Ni), iron (Fe), chromium (Cr), aluminum (Al), copper (Cu), manganese (Mn), zinc (Zn) or alloys thereof. Preferred combinations can include NiFeCrAl, NiCrAl, FeCrAl, ZnMo, MoFe, MoMn, CuZn, CuFe, Fe, Cu, Mn, Zn, or Ni. In some instances, the catalytically active metal can be sinter resistant. In specific instances, the catalyst does not include an inert support material such as a ceramic support, a metal support, a metal coating, a binder, or combinations thereof. The 3-D structure of the bulk catalyst of the present invention can include a foam structure, a honeycomb structure, or a mesh structure. In some aspects, when the bulk catalyst has a foam 3-D structure, the structure can be porous with a pore size of 100 μm to 10000 μm, preferably 300 to 600 μm, or have a surface area of 1 to 100 m²/g, or both. In specific instances, the outer surface can include a catalytically active metal sulfide or oxide layer, or a catalytically active metal alloy sulfide or oxide layer. The morphology of the sulfide layer can include a flaky uneven structure, a well-defined defect free layer, or randomly oriented whiskers. In other aspects, the 3-D structure can include a cubic, cylindrical or spherical shape including 1) a cubic shape having side length of 0.2 to 2 cm, 2) a spherical dimension having a diameter of 0.1 to 2 cm or 3) a cylindrical shape having dimensions of a radius of 0.1 to 1 cm, and a height of 0.2 to 2 cm. In some instances, the 3-D structure can be hollow or solid and/or be formed into a tablet or multi-hollow pellets. In some instances, the 3-D structure is hollow and the wall thickness of the hollow structure can be 500 micron to 5 mm. In still other instances, the catalysts of the present invention can exhibit a pressure drop of less than 0.5 bar over a bed length of 4 to 10 cm during use in a catalytic reaction.

In another embodiment, a method for producing the bulk three-dimensional (3-D) catalyst of the current invention is described. The method can include: (a) obtaining a melted catalytic metal or metal alloy; (b) contacting the melted catalytic metal or metal alloy with a gaseous sulfurizing agent under conditions sufficient to sulfurize the metal or metal alloy; and (c) forming the melted sulfurized catalytic metal or metal alloy into a three-dimensional (3-D) structure catalyst of the current invention. In one aspect, the sulfurizing conditions include a temperature of 300° C. to 1000° C., preferably 350° C. to 500° C. In another aspect, the sulfurizing agent includes elemental sulfur vapors, hydrogen sulfides, sulfur dioxide, dimethyl sulfoxide, carbon disulfide, or combinations thereof. The method can also include calcining the melted catalytic metal or metal alloy prior to step (b).

In yet another embodiment, a method for producing the bulk three-dimensional (3-D) metal sulfide or oxide catalyst of the present invention can include: (a) forming catalytically active metals into a 3-D catalytically active metal structure; and (b) subjecting the 3-D catalytically active metal structure to conditions suitable to sulfide or oxidize the surface of the catalytic metal of the catalytic metal structure to produce the 3-D metal catalyst of the present invention. In one aspect, the conditions of step (b) can include heating the 3-D catalytically active metal structure in the presence of carbon dioxide, oxygen, or water, or combinations thereof, at 350° C. to 1000° C. The conditions of step (b) can also include contacting the 3-D catalytically active metal structure or the oxidized 3-D catalytically active metal structure with elemental sulfur vapor, hydrogen sulfide, sulfur dioxide, dimethyl sulfoxide, carbon disulfide, or combinations thereof.

In still another embodiment, a method of producing carbon monoxide (CO) and sulfur dioxide (SO₂) is described. The method can include: (a) obtaining a reaction mixture that includes carbon dioxide gas (CO₂(g)) and elemental sulfur; and (b) contacting the reaction mixture with the bulk three-dimensional (3-D) catalysts of the present invention under reaction conditions sufficient to produce a product stream that includes CO (g) and SO₂(g). In one aspect, the product stream can include carbonyl sulfide (COS). In another aspect, the product stream can include carbon disulfide CS₂. The reaction conditions can include a temperature of 250° C. to 3000° C., 900° C. to 2000° C., or 1000° C. to 1600° C., a pressure of 1 to 25 bar, and a gas hourly space velocity (GHSV) of 1,000 to 100,000 or combinations thereof

Also disclosed is a system for producing carbon monoxide (CO) and sulfur dioxide (SO₂) using the bulk three-dimensional (3-D) catalyst of the present invention. The system can include: (a) an inlet for a feed comprising a carbon dioxide gas (CO₂(g)) and elemental sulfur gas (S₂(g)) or a first inlet for a feed comprising CO₂(g) and a second inlet for a feed comprising S₂(g); (b) a reactor that can include a reaction zone configured to be in fluid communication with the inlet or inlets; and (c) an outlet configured to be in fluid communication with the reaction zone to remove a product stream comprising CO(g) and SO₂(g). The reaction zone can include CO₂(g) and S₂(g) and the bulk three-dimensional (3-D) catalysts of the present invention.

In one particular aspect of the invention 20 embodiments are described. Embodiment 1 is a bulk three-dimensional (3-D) catalyst that includes a catalytically active metal or metal alloy having a 3-D structure comprising the catalytically active metal or metal alloy having a sulfurized or oxidized outer surface. Embodiment 2 is the bulk three-dimensional (3-D) catalyst of embodiment 1, wherein the catalytic metal or metal alloy comprises an alkaline earth metal, a transition metal, a post-transition metal, any combination thereof, or any alloy thereof. Embodiment 3 is the bulk three-dimensional (3-D) catalyst of embodiment 2, wherein the catalytically active metal is nickel (Ni), iron (Fe), chromium (Cr), aluminum (Al), copper (Cu), manganese (Mn), zinc (Zn) or alloys thereof, preferably NiFeCrAl, NiCrAl, FeCrAl, ZnMo, MoFe, MoMn, CuZn, CuFe, Fe, Cu, Mn, Zn, or Ni. Embodiment 4 is the bulk three-dimensional (3-D) catalyst of any one of embodiments 1 to 3, wherein the catalytically active metal is sinter resistant. Embodiment 5 is the bulk three-dimensional (3-D) catalyst of any one of embodiments 1 to 4, wherein the catalyst does not include a ceramic support, a metal support, a metal coating, a binder, or combinations thereof. Embodiment 6 is the bulk three-dimensional (3-D) catalyst of any one of embodiments 1 to 5, wherein the 3-D structure is a foam structure, a honeycomb structure, or mesh structure. Embodiment 7 is the bulk three-dimensional (3-D) catalyst of embodiment 6, wherein the 3-D structure is a foam having a pore size from 100 μm to 10000 μm, preferably 300 to 600 μm, a surface area of 1 to 100 m²/g, or both. Embodiment 8 is the bulk three-dimensional (3-D) catalyst of any one of embodiments 1 to 7, wherein the outer surface comprises a catalytically active metal sulfide or oxide layer or a catalytically active metal alloy sulfide or oxide layer, and the morphology of the sulfide layer comprises a flaky uneven structure, a well-defined defect free layer, or randomly oriented whiskers. Embodiment 9 is the bulk three-dimensional (3-D) catalyst of any one of embodiments 1 to 8, wherein the 3-D structure comprises a cubic, cylindrical or spherical shape. Embodiment 10 is the bulk three-dimensional (3-D) catalyst of embodiment 9, wherein the 3-D structure comprises 1) a cubic shape having side length of 0.2 to 2 cm, 2) a spherical dimension having a diameter of 0.1 to 2 cm or 3) a cylindrical shape having dimensions of a radius of 0.1 to 1 cm, and a height of 0.2 to 2 cm. Embodiment 11 is the bulk three-dimensional (3-D) catalyst of any one of embodiments 1 to 10, wherein the 3-D structure is hollow, solid, a tablet, or multi-hollow pellets. Embodiment 12 is the bulk three-dimensional (3-D) catalyst of any one of embodiments 10 to 11, wherein the 3-D structure catalyst is hollow and the wall thickness of the hollow structure is from 500 micron to 5 mm. Embodiment 13 is the bulk three-dimensional (3-D) catalyst of any one of embodiments 1 to 12, wherein the 3-D structure catalyst possess a pressure drop of less than 0.5 bar over a bed length of 4 to 10 cm.

Embodiment 14 is a method for producing the bulk three-dimensional (3-D) catalyst of any one of embodiments 1 to 13, the method comprising: (a) obtaining a melted catalytic metal or metal alloy; (b) contacting the melted catalytic metal or metal alloy with a gaseous sulfurizing agent under conditions sufficient to sulfurize the metal or metal alloy; and (c) forming the melted sulfurized catalytic metal or metal alloy into a three-dimensional (3-D) structure catalyst of any one of embodiments 1 to 13. Embodiment 15 is the method of embodiment 14, wherein the sulfurizing conditions comprise a temperature of 300° C. to 1000° C., preferably 350° C. to 500° C. Embodiment 16 is the method of any one of embodiment 14 to 15, wherein the sulfurizing agent comprises elemental sulfur vapor, hydrogen sulfide, sulfur dioxide, dimethyl sulfoxide, carbon disulfide, or combinations thereof. Embodiment 17 is the method of any one of embodiments 14 to 16, further comprising calcining the melted catalytic metal or metal alloy prior to step (b).

Embodiment 18 is a method for producing the bulk three-dimensional (3-D) metal sulfide or oxide catalyst of any one of embodiments 1 to 13, the method comprising: (a) forming catalytically active metals into a 3-D catalytically active metal structure; and (b) subjecting the 3-D catalytically active metal structure to conditions suitable to sulfurize or oxidize the surface of the catalytic metal of the catalytic metal structure to produce the 3-D metal catalyst of any one of embodiments 1 to 13. Embodiment 19 is the method of embodiment 18, wherein the conditions of step (b) comprise heating the 3-D catalytically active metal structure in the presence of carbon dioxide, oxygen or water at 350° C. to 1000° C. or the conditions of step (b) comprise contacting the 3-D catalytically active metal structure or the oxidized 3-D catalytically active metal structure with elemental sulfur vapor, hydrogen sulfide, sulfur dioxide, dimethyl sulfoxide, carbon disulfide, or combinations thereof.

Embodiment 19 is a method of producing carbon monoxide (CO) and sulfur dioxide (SO₂), the method comprising: (a) obtaining a reaction mixture comprising carbon dioxide gas (CO₂(g)) and elemental sulfur; and (b) contacting the reaction mixture with any one of the bulk three-dimensional (3-D) catalysts of embodiments 1 to 13 under conditions sufficient to produce a product stream comprising CO (g) and SO₂(g).

Other embodiments of the invention are described throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions of the invention can be used to achieve methods of the invention.

The following includes definitions of various terms and phrases used throughout this specification.

The term “catalyst” means a substance, which alters the rate of a chemical reaction.

“Catalytic” or “catalytic active” means having the properties of a catalyst.

The term “inert” means a substance, which does not participate in any chemical reaction described throughout the specification.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising”, “including”, “containing”, or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The bulk three-dimensional (3-D) catalysts of the present invention can “comprise,” “consist essentially of” or “consist of” particular ingredients, components, compositions, etc. disclosed throughout the specification. With respect to the transitional phase “consisting essentially of,” in one non-limiting aspect, a basic and novel characteristic of the bulk three-dimensional (3-D) catalysts of the present invention is that catalytically active metal(s) forms the 3-D structure of the catalyst without the need for inert support materials. Still further, the catalysts of the present invention can be used in high temperature reactions (e.g., 800° C. to 1500° C.).

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a representative structure of a 3-D structure of a disordered porous metallic foam that can be formed from catalytically active metal(s) or metal alloy(s).

FIG. 2 is an illustration of a 3-D honeycomb structure that can be formed from catalytically active metal(s) or metal alloy(s).

FIG. 3 shows a cross-sectional illustration of an outer surface of a 3-D catalyst of the present invention having a single sulfide or oxide phase layer.

FIG. 4 shows a cross-sectional illustration of an outer surface of a 3-D catalyst of the present invention having two separate sulfide and/or oxide phase layers.

FIG. 5 shows a cross-sectional illustration of an outer surface of a 3-D catalyst of the present invention having three separate sulfide and/or oxide phase layers.

FIG. 6 is a schematic of a system to prepare carbon monoxide (CO) and sulfur dioxide (SO₂) using a 3-D catalyst of the present invention.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

A solution that overcomes the problems associated with the use of heterogeneous catalysts for high temperature applications has been discovered. The solution is premised on a catalyst that contains a catalytically active metal or metal alloy three-dimensional (3-D) structure having a sulfurized or oxidized outer surface, where the catalytically active metal or metal alloy forms the 3-D structure.

These and other non-limiting aspects of the present invention are discussed in further detail in the following sections with reference to the Figures.

### A. 3-D Metal or Metal Alloy Catalysts

The bulk catalysts of the present invention can include a catalytically active metal or metal alloy three-dimensional (3-D) structure.

### 1. Catalytic Material

The catalytic active metal or metal alloy can be a metal, a mixed metal oxide, a metal oxysulfide, or a mixed metal sulfide containing an alkaline earth metal, a transition metal, a post-transition metal, or any combination alloy thereof from Columns 2 to 13 of the Periodic Table. Possible transition metals include yttrium (Y), zirconium (Zr), vanadium (V), niobium (Nb), tantalum (Ta), tungsten (W), manganese (Mn), rhenium (Rh), iron (Fe), chromium (Cr), cobalt (Co), iridium (Ir), nickel (Ni), copper (Cu), zinc (Zn) or alloys thereof. Preferably the transition metals include nickel (Ni), iron (Fe), copper (Cu), manganese (Mn), zinc (Zn) or alloys thereof. Possible post-transition metals include aluminum (Al), gallium (Ga), indium (In), silicon (Si), germanium (Ge), tin (Sn), antimony (Sb), bismuth (Bi), or alloys thereof. Preferably, the post-transition metal is aluminum (Al). Possible alkaline earth metals include magnesium (Mg), calcium (Ca), strontium (Sr), barium (Ba) or combinations thereof. Preferably, alloys including the above mention metals include NiFeCrAl, NiCrAl, FeCrAl, ZnMo, MoFe, MoMn, CuZn, or CuFe. A non-limiting commercial source of the metals for use in the current invention includes Sigma-Aldrich®, (U.S.A.), Alfa Aesar (U.S.A.), and Fischer Scientific (U.S.A.).

### 2. Catalyst Structure

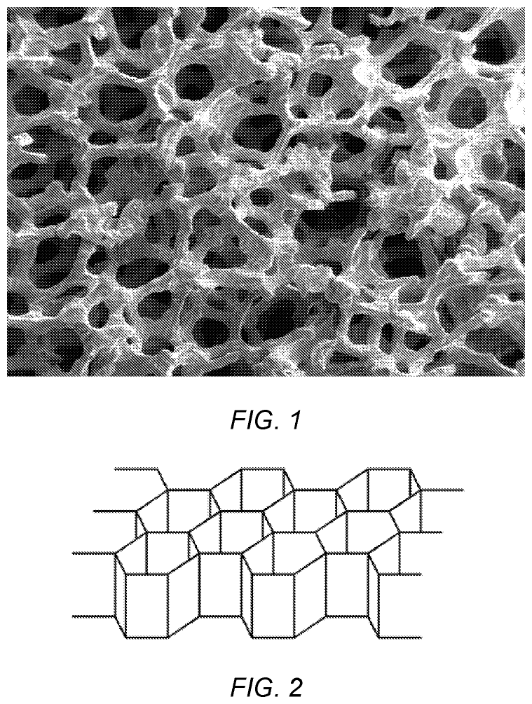

The catalytic active metal or metal alloy of the bulk catalyst of the present invention can have a three-dimensional (3-D) structure. In one embodiment, the three-dimensional (3-D) structure can have a foam structure, a honeycomb structure, or mesh structure. In one aspect, the three-dimensional (3-D) structure is that of a metal or metal alloy foam that is highly porous having a large surface area to enhance surface to volume ratios. The pore structure of the foam can be uniform or disordered and have a variety of pore sizes. FIG. 1 shows a structure of a disordered porous metallic foam. In some instances, the pore structure of the metal foam can contain regions that obey mathematically defined minimal surfaces having three-dimensional (3-D) tessellations or honeycombs. The pore structure can also contain regions of a Weaire-Phelan structures having an optimal unit cell with essentially perfect or perfect order within the three-dimensional (3-D) matrix. The metal pore structure walls can form interconnected metal lamella that can be connected in triads, tetrads, pentads, hexads, etc., and radiate outward from the metallic connection points. In preferred aspects, pore sizes of the three-dimensional (3-D) metallic foam structure can range from 100 μm to 10000 μm, preferably 300 to 600 μm or can be at least, equal to, or between any two of 100 μm, 500 μm, 1000 μm, 1500 μm, 2000 μm, 2500 μm, 3000 μm, 3500 μm, 4000 μm, 4500 μm, 5000 μm, 5500 μm, 6000 μm, 6500 μm, 7000 μm, 7500 μm, 8000 μm, 8500 μm, 9000 μm, 9500 μm, and 10000 μm and/or have a surface area of 1 to 100 m²/g or at least, equal to, or between any two of 1, 5, 10, 15, 20, 25, 30, 35, 40, 45, 50, 55, 60, 65, 70, 75, 80, 85, 90, 95, and 100 m²/g. In other aspects, the metal or metal alloy can have a honeycomb structure that is formed from stacked layers or slabs of prisms based on various tessellations of the plane. FIG. 2 illustrates a generic honeycomb structure. Although not shown, it is contemplated that the honeycomb structure can have a three-dimensional (3-D) uniform regular cubic or quasi-regular octahedra or tetrahedra honeycomb, such as one or more of the five space-filling isochoric polyhedral (e.g., cuboidal honeycomb, hexagonal prismatic honeycomb, rhombic dodecahedral honeycomb, elongated dodecahedral honeycomb, and bitruncated cubic honeycomb). In still further aspects, the metal or metal alloy can have a mesh structure that contains connected strands of metal or alloy, such as a three-dimensional (3-D) metallic web or net. Without being limited by theory, the catalytic active metal or metal alloy of the present invention can have mixtures of any of the above-mentioned foam, honeycomb, or mesh structures in a three-dimensional (3-D) structural arrangement.

In another embodiment, the three-dimensional (3-D) structure of the bulk catalyst of the present invention can have a hollow or solid cubic shape, cylindrical shape, or spherical shape. Exemplary hollow and solid structures includes tablets or multi-hollow pellets. In one aspect, the catalyst has a hollow or solid cubic shape having a side length of 0.2 to 2 cm, or at least, equal to, or between any two of 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0 cm. In another aspect, the catalyst has a hollow or solid spherical shape having a spherical diameter of 0.1 to 2 cm, or at least, equal to, or between any two of 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2 cm. Exemplary spherical shapes can include any of hollow or solid octahedron, dodecahedron, icosahedron, truncated icosahedron (e.g., soccer ball), fullerene, etc., and derivatives thereof, or higher geodesic sphere structures. In yet another aspect, the catalyst has a hollow or solid cylindrical shape having a radius of 0.1 to 1 cm, or at least, equal to, or between any two of 0.1, 0.2, 0.3, 0.4, 0.5, 0.6, 0.7, 0.8, 0.9, and 1 cm, and a height of 0.2 to 2 cm, or at least, equal to, or between any two of 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2 cm. In one aspect, the cylindrical shape may not be symmetrical (e.g., it can have a cone shape). Typically, when the three-dimensional (3-D) structures are cylindrical they can also be hollow averaging from 2 to 20 or 3 to 10, or at least, equal to, or between any two of 1, 2, 3, 4, 5, 6, 7, 8, 9, 10, 11, 12, 13, 14, 15, 16, 17, 18, 19, and 20 hollow structures per pellet.

In certain aspects, a hollow three-dimensional (3-D) structure can advantageously reduce the weight of the catalyst to increase productivity and mass transfer limitations. When the three-dimensional (3-D) structure of the catalyst is hollow, the wall thickness of the hollow structure can be from 500 micron (0.5 mm) to 5 mm, or at least, equal to, or between any two of 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, and 5 mm depending upon the overall dimension of the three-dimensional (3-D) metal structure.

In particular embodiments, the catalytically active metal of the three-dimensional (3-D) catalyst of the present invention can resist sintering during high temperature catalytic applications. The catalyst can be partially, substantially, or completely sinter resistant at a range or specific reaction temperatures. Exemplary reaction temperatures include where the catalyst of the present invention is partially, substantially, or completely sinter resistant includes 800° C. to 1500° C., or at least, equal to, or between any two of 800, 850, 900, 950, 1000, 1050, 1100, 1150, 1200, 1250, 1300, 1350, 1400, 1450, and 1500° C.

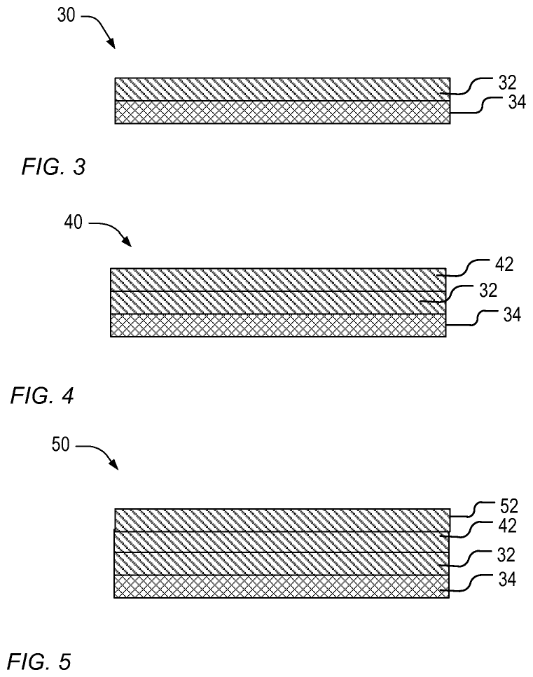

The outer surface of the 3-D catalyst can include one or more sulfide or oxide layers formed through an in situ process. FIG. 3 shows a schematic of a cross-sectional view of an outer surface of a 3-D catalyst 30 having single sulfide or oxide phase layer 32 on active (catalytic) metal layer 34. FIG. 4 shows a schematic of a cross-sectional view of an outer surface of a 3-D catalyst 40 having first sulfide or oxide phase layer 32 between second sulfide or oxide phase layer 42 and active metal layer 34. Said another way, catalyst 40 includes 2 oxides layers on the surface of the catalytic metal. FIG. 5 shows a schematic of a cross-sectional view of an outer surface of a 3-D catalyst 50 of the present invention having three sulfide or oxide layers. In FIG. 5, active metal layer 34, first sulfide or oxide phase layer 32, second sulfide or oxide phase layer 42, and third sulfide or oxide phase layer 52 are depicted. The sulfide and/or oxide layers of the present invention can be mixtures of sulfurized and oxidized metals or metal alloys that can be formed under subsequent sulfurizing and oxidizing conditions where the first sulfurization or oxidation conditions provide partial or incomplete sulfurization or oxidation or where sulfurization or oxidation occurs with previously sulfurized or oxidized surface metal or metal alloys. In some embodiments, in situ sulfurization or oxidation of metal or metal alloy catalysts can occur under substrate to product sulfurization or oxidation reaction conditions, so that spent catalyst can be regenerated in situ to active catalyst to improve the efficiency of the overall catalytic process. The surface metals and alloy metals as well as metals and metal alloys below the surface of the 3-D catalyst can be sulfurized or oxidized during the processes of the current invention. In particular instances, the morphology of the sulfide layer can include a flaky uneven structure, a well-defined defect free layer, or randomly oriented whiskers.

### B. Method to Make the 3-D Catalyst of the Present Invention

The catalysts of the current invention can be prepared by various methods. Since the catalysts are intended for used in chemical process involving high reaction temperature, the success of these applications require a thermally stable and sinter resistant active catalytic matrix. In a particular aspect, the method enables the development of a 3-D structure formed from active catalytic metal(s) or metal alloy(s). The surface of the 3-D structure can be sulfurized as shown in general reaction scheme (1) or first oxidized followed by sulfurization as shown in general scheme (2)

M→MS (1)

M→MO→MS (2)

where M is any sulfidizable metal.

By way of example, the sulfide surface can be achieved by heating in the metal in the presence of a sulfur source, such as elemental sulfur vapor, hydrogen sulfide, sulfur dioxide, dimethyl sulfoxide, carbon disulfide, or combinations thereof. Alternatively, the metal can be first oxidized by calcining in air, oxygen enriched air, CO₂, O₂, or H₂O atmosphere at elevated temperature. The metal oxide can then be exposed to the aforementioned sulfur source to convert the metal oxide to metal sulfide. In an exemplary embodiment, iron sulfide (FeS) can be prepare by directly from iron (Fe) by sulfurization with hydrogen sulfide as shown in scheme (3) or indirectly by first oxidation to ferric oxide as shown in scheme (4), followed by subsequent sulfurization as shown in scheme (5).

Fe+H₂S→FeS+H₂ (3)

2Fe+½O₂→Fe₂O₃ (4)

Fe₂O₃+2H₂S→2FeS+2H₂O+½O₂ (5)

In one aspect, the method of preparation can include melting a catalytic metal or metal alloy. The melted catalytic metal or metal alloy can then be treated with a gaseous sulfurizing agent to sulfurize the metal or metal alloy. In some aspects, the melted catalytic metal or metal alloy can first be calcined at a suitable temperature in the presence of an oxygen source (e.g., air, oxygen enriched air) prior to sulfurization. The sulfurized melted catalytic metal or metal alloy can then be formed into a three-dimensional (3-D) structure catalyst of the current invention. In non-limited aspects, metallic three-dimensional (3-D) foams can be made by gas injection of the melted catalytic metal or metal alloy, by the incorporation of a blowing agent (e.g., TiH₂) into the melted catalytic metal or metal alloy, powder, or ingots, or by solid-gas eutectic solidification (GASARS). In one aspect, the sulfurizing conditions include a temperature of 300° C. to 1000° C., preferably 350° C. to 500° C., or at least, equal to, or between any two of 300, 350, 400, 450, 500, 550, 600, 650, 700, 750, 800, 850, 900, 950, and 1000° C. The sulfurizing agent can include elemental sulfur vapors, hydrogen sulfides, sulfur dioxide, dimethyl sulfoxide, carbon disulfide, or combinations thereof.

In another aspect, the bulk 3-D metal sulfide or oxide catalyst of the present invention can include first forming catalytically active metals or metal alloys into a 3-D catalytically active metal structure. The formed 3-D catalytically active metal structure can then be sulfurized or oxidized to produce the 3-D metal catalyst of the present invention. The 3-D catalytically active metal structure can be reduced in size using known reduction techniques (e.g., grinding, sieving, or the like). The resulting 3-D catalyst is substantially devoid of inert materials such as ceramic supports, binders and the like.

### C. Carbon Monoxide and Sulfur Dioxide Production Process

The bulk three-dimensional (3-D) catalyst of the present invention can be used as a catalyst in a variety of industrial and high temperature applications. The reaction processing conditions can be varied to achieve a desired result (e.g., carbon monoxide and sulfur dioxide product). In a preferred aspect, the process can include contacting a feed stream of carbon dioxide gas (CO₂(g)) and elemental sulfur with any of the catalysts described throughout the specification under conditions sufficient to produce a product stream comprising CO (g) and SO₂(g). In some aspects, the product stream can further include carbonyl sulfide (COS) and/or carbon disulfide (CS₂).

In one aspect of the invention, the catalyst of the present invention can be used in continuous flow reactors to produce carbon monoxide (CO) and sulfur dioxide (SO₂) from carbon dioxide gas (CO₂(g)) and elemental sulfur. Non-limiting examples of the configuration of the catalytic material in a continuous flow reactor are provided below and throughout this specification. The continuous flow reactor can be a fixed bed reactor, a stacked bed reactor, a fluidized bed reactor, or an ebullating bed reactor. In a preferred aspect of the invention, the reactor is a fixed bed reactor. The catalytic material can be arranged in the continuous flow reactor in layers (e.g., catalytic beds) or mixed with the reactant stream (e.g., ebullating bed).

Non-limiting processing conditions can include temperature, pressure, reactant flow, a ratio of reactants, or combinations thereof. Process conditions can be controlled to produce carbon monoxide (CO) and sulfur dioxide (SO₂) with specific properties (e.g., percent CO, percent SO₂, etc.). The average temperature in the reactor sufficient to produce a product stream includes a reaction temperature of 250° C. to 3000° C., 900° C. to 2000° C., or 1000° C. to 1600° C. or at least, equal to, or between any two of 250, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, and 3000° C. Pressure in the reactor sufficient to produce a product stream can include a reaction pressure of between 1 and 25 bar, or at least, equal to, or between any two of 1, 2, 3, 4, 5, 6, 7, 8, 9, 10, 11, 12, 13, 14, 15, 16, 17, 18, 19, 20, 21, 22, 23, 24, and 25 bar. 1 bar is equal to 0.1 MPa. The gas hourly space velocity (GHSV) of the reactant feed can range from 1,000 h⁻¹ to 100,000 h⁻¹, or at least, equal to, or between any two of 1,000, 5,000, 10,000, 15,000, 20,000, 30,000, 40,000, 50,000, 60,000, 70,000, 80,000, 90,000, and 100,000 h⁻¹. In some embodiments, the GHSV is as high as can be obtained under the reaction conditions. The process conditions can be adjusted to maintain optimum conditions for conversion to produce CO (g) and/or SO₂ by changing the hydrocarbon source, the sulfur source, the reactant gas ratio, pressure, flow rates, the temperature of the process, the catalyst type, and/or catalyst to feed ratio. In one particular aspect of the present invention, the bulk 3-D catalyst has the ability to affect a pressure drop of less than 0.5 bar over a bed length of 4 to 10 cm during use in a catalytic reaction.

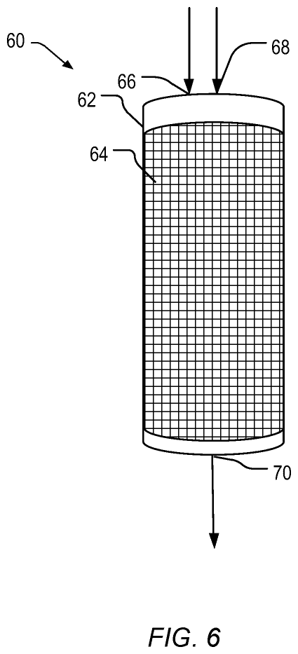

In a non-limited embodiment, a system for producing carbon monoxide (CO) and sulfur dioxide (SO₂) using the bulk 3-D catalyst of the present invention is described. Referring to FIG. 6, a schematic of system 60 for the production of carbon monoxide (CO) and sulfur dioxide (SO₂) is depicted. System 60 may include a continuous flow reactor or an adiabatic reactor 62 and a catalytic material 64 (shown as a mesh). In a preferred embodiment, catalytic material 64 is the catalyst of the present invention. A reactant stream that includes carbon dioxide gas (CO₂(g)) can enter the continuous flow reactor 62 via feed inlet 66. An elemental sulfur gas (S₂(g)) can be provided via feed inlet 68. The reactants can be provided to the continuous flow reactor 62 such that the reactants mix in the reactor to form a reactant mixture prior to contacting catalytic material 64. In some aspects of the invention, carbon dioxide gas (CO₂(g)) and elemental sulfur gas (S₂(g)) are provided as a gas mixture and are fed to the reactor via one inlet (not shown). The reaction zone where catalytic material 64 comes into contact with the reactant feed can be in fluid communication with the inlet(s) and outlet(s). In some embodiments, the catalytic material and the reactant feed can be heated to approximately the same temperature. In some instances, the catalytic material 64 can be layered in the continuous flow reactor 62 or positioned in one or more tubes in an adiabatic reactor. In particular aspects, the system can permit in situ sulfurization of the catalytic material before, during, or after the reaction. The amount of elemental sulfur gas (S₂(g)) can be controlled to affect the rate of catalyst sulfurization/regeneration. Contact of the reactant mixture with catalytic material 64 can produce a carbon monoxide (CO) and sulfur dioxide (SO₂) product stream. The product stream can exit continuous flow reactor 62 via product outlet 70. Without being limited to theory, it is believed that carbonyl sulfide (COS), and/or carbon disulfide (CS₂) can also be contained in the product stream.

The process of the present invention can produce a product stream that includes a composition containing carbon monoxide (CO), sulfur dioxide (SO₂), and optionally carbonyl sulfide (COS) and/or carbon disulfide (CS₂). Any of the products contained in the product stream can be suitable as an intermediates or as feed material in a subsequent synthesis reactions to form a chemical product or a plurality of chemical products. The product composition can be purified or mixtures of reaction products can be separated using known purification and separation methods (e.g., cryogenic distillation, membrane separation, swing adsorption techniques, etc.).

The reactants used in the systems employing the bulk three-dimensional (3-D) catalyst of the present invention can include carbon dioxide, carbon monoxide, oxygen, and elemental sulfur gas (S₂(g)). In one non-limiting instance, the CO₂ can be obtained from a waste or recycle gas stream (e.g., from a plant on the same site such as from ammonia synthesis, or a reverse water gas shift reaction) or after recovering the carbon dioxide from a gas stream. O₂ can come from various sources, including streams from water-splitting reactions, or cryogenic separation systems. Sulfur gas (S₂(g)) in the context of the present invention can include all allotropes of sulfur (i.e., Sn where n=1 to ∞). Non-limiting examples of sulfur allotropes include S, S₂, S₄, S₆, and S₈, with the most common allotrope being S₈. Sulfur gas can be obtained by heating solid or liquid sulfur to a boiling point of about 445° C. Alternatively, gaseous sulfur can be generated by heating elemental sulfur in a sealed container and the gaseous sulfur can then be added to the reactor or mixed with the reactant gas feed. Solid sulfur can contain either (a) sulfur rings, which may have 6, 8, 10 or 12 sulfur atoms, with the most common form being S₈, or (b) chains of sulfur atoms, referred to as catena sulfur having the formula S. Liquid sulfur is typically made up of S₈ molecules and other cyclic molecules containing a range of six to twenty atoms. Solid sulfur is generally produced by extraction from the earth using the Frasch process or the Claus process. The Frasch process extracts sulfur from underground deposits. The Claus process produces sulfur through the oxidation of hydrogen sulfide (H₂S). Hydrogen sulfide can be obtained from waste or recycle stream (for example, from a plant on the same site, or as a product from hydrodesulfurization of petroleum products) or recovery the hydrogen sulfide from a gas stream (for example, separation for a gas stream produced during production of petroleum oil, natural gas, or both). Sulfur dioxide (SO₂) can be obtained from the burning of sulfur or materials containing sulfur, reduction of higher oxide (i.e., CaSO₄), or from the acidification of sodium metabisulfite. A benefit of using sulfur as a starting material is that it is abundant and relatively inexpensive to obtain as compared to, for example, oxygen gas. The reactant mixtures may further contain other gases, preferably other gases that do not negatively affect the reaction (e.g., reduced conversion and/or reduced selectivity). Examples of such other gases include nitrogen or argon. In some aspects of the invention, the reactant stream can be substantially devoid of other reactant gas such as oxygen gas, carbon dioxide gas, hydrogen gas, water or any combination thereof. Preferably, the reactant mixture is highly pure and substantially devoid of water. In some embodiments, the gases can be dried prior to use (e.g., pass through a drying media) or contain a minimal amount of water or no water at all. Water can be removed from the reactant gases with any suitable method known in the art (e.g., condensation, liquid/gas separation, etc.). A non-limiting commercial source of the reactants used in the current invention includes Sigma-Aldrich®, (U.S.A.), Alfa Aesar (U.S.A.), and Fischer Scientific (U.S.A.).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Prophetic Example 1

### Formation of Metal Foams and Metal Foils—General Procedure

Materials. Metal substrates will be purchased from available vendors; one such example would be http://www.metalsubstrate.com and used for further processing.

Procedures. The procedure of Jatkar, (“A New Catalyst Support Structure for Automotive Catalytic Converters,” SAE International: 1997 DOI:10.4271/971032) will be modified to prepare a metal foam of the present invention. A metal or metal alloy will be heated to the melting point of the metal or alloy. A sulfurizing agent will be injected into the molten metal to form a metal foam. A high temperature foaming agent will be used to stabilize molten metal bubbles. Perforated foils will be made following the procedure of Roychoudhury, et al., “Development and Performance of Microlith™ Light-Off Preconverters for LEV/ULEV” SAE International: 1997, DOI:10.4271/971023.

### Prophetic Example 2

### Oxidation or Sulfidation of Metal Substrates—General Procedure

Oxidation or sulfidation of metal substrates will be performed in the laboratory. The metal substrate or metal foam will be placed in a quartz reactor and any gap between the inner wall of the quartz reactor and outer surface of the metal substrate or foam will be removed by hot pressing the quartz reactor. The purpose of doing this is to direct all feed gasses through the catalytic surface and measure realistic catalytic performance. The metal substrate or foam will be first sulfided with a suitable sulfiding agent and then employed in a catalytic transformation. Feed gas and outlet gas are analyzed by gas chromatography.

### Prophetic Example 3

### Zinc Sulfide Foam

Zinc sulfide foam, will be made by melting metallic zinc at 500° C. and injecting hydrogen sulfide as the sulfurizing agent in a closed system. Titanium hydride will be used as a foaming agent to ensure a homogeneous bubbling along the process. When cooled, the catalyst will be ready to be used to chemical reaction.

### Prophetic Example 4

### Oxidation of Carbon Dioxide Reaction

Two hundred milligrams of the zinc sulfide foam of Example 3 will be loaded into a quartz tube (ID of about 10 mm). The catalyst will be sandwiched between two layers of silicon carbide (600 μm) and supported by quartz wool to ensure proper positioning into isothermal zone. The catalyst will be heated to the desired temperature (about 1100° C.) and then will be exposed to a gas mixture of CO₂, sulfur (S₂) and nitrogen with a molar composition of 4:1:10, respectively at a gas hourly space velocity (GHSV) of 4000 h⁻¹. The unreacted sulfur will be trapped into a condenser after the reactor and the remaining effluent will be analyzed by a micro gas chromatography composed of molecular sieve with a poraplot type column.

1. A bulk three-dimensional (3-D) catalyst comprising a catalytically active metal or metal alloy having a 3-D structure comprising the catalytically active metal or metal alloy having a sulfurized or oxidized outer surface.

2. The bulk three-dimensional (3-D) catalyst of claim 1, wherein the catalytic metal or metal alloy comprises an alkaline earth metal, a transition metal, a post-transition metal, any combination thereof, or any alloy thereof.

3. The bulk three-dimensional (3-D) catalyst of claim 2, wherein the catalytically active metal is nickel (Ni), iron (Fe), chromium (Cr), aluminum (Al), copper (Cu), manganese (Mn), zinc (Zn) or alloys thereof.

4. The bulk three-dimensional (3-D) catalyst of claim 1, wherein the catalytically active metal is sinter resistant.

5. The bulk three-dimensional (3-D) catalyst of claim 1, wherein the catalyst does not include a ceramic support, a metal support, a metal coating, a binder, or combinations thereof.

6. The bulk three-dimensional (3-D) catalyst of claim 1, wherein the 3-D structure is a foam structure, a honeycomb structure, or mesh structure.

7. The bulk three-dimensional (3-D) catalyst of claim 6, wherein the 3-D structure is a foam having a pore size from 100 μm to 10000 μm, a surface area of 1 to 100 m²/g, or both.

8. The bulk three-dimensional (3-D) catalyst of claim 1, wherein the outer surface comprises a catalytically active metal sulfide or oxide layer or a catalytically active metal alloy sulfide or oxide layer, and the morphology of the sulfide layer comprises a flaky uneven structure, a well defined defect free layer, or randomly oriented whiskers.

9. The bulk three-dimensional (3-D) catalyst of claim 1, wherein the 3-D structure comprises a cubic, cylindrical or spherical shape.

10. The bulk three-dimensional (3-D) catalyst of claim 9, wherein the 3-D structure comprises 1) a cubic shape having side length of 0.2 to 2 cm, 2) a spherical dimension having a diameter of 0.1 to 2 cm, 3) a cylindrical shape having dimensions of a radius of 0.1 to 1 cm, and a height of 0.2 to 2 cm.

11. The bulk three-dimensional (3-D) catalyst of claim 1, wherein the 3-D structure is hollow, solid, a tablet, or multi-hollow pellets.

12. The bulk three-dimensional (3-D) catalyst of claim 1, wherein the 3-D structured catalyst consists essentially of the catalytically active metal or metal alloy having a sulfurized or oxidized outer surface.

13. The bulk three-dimensional (3-D) catalyst of claim 1, wherein the 3-D structured catalyst possess a pressure drop of less than 0.5 bar over a bed length of 4 to 10 cm.

14. A method for producing the bulk three-dimensional (3-D) catalyst of claim 1, the method comprising:
(a) obtaining a melted catalytic metal or metal alloy;
(b) contacting the melted catalytic metal or metal alloy with a gaseous sulfurizing agent under conditions sufficient to sulfurize the metal or metal alloy; and
(c) forming the melted sulfurized catalytic metal or metal alloy into a three-dimensional (3-D) structure catalyst of claim 1.

15. The method of claim 14, wherein the sulfurizing conditions comprise a temperature of 300° C. to 1000° C.

16. The method of claim 14, wherein the sulfurizing agent comprises elemental sulfur vapor, hydrogen sulfide, sulfur dioxide, dimethyl sulfoxide, carbon disulfide, or combinations thereof.

17. The method of claim 14, further comprising calcining the melted catalytic metal or metal alloy prior to step (b).

18. A method for producing the bulk three-dimensional (3-D) metal sulfide or oxide catalyst of claim 1, the method comprising:
(a) forming catalytically active metals into a 3-D catalytically active metal structure; and
(b) subjecting the 3-D catalytically active metal structure to conditions suitable to sulfurize or oxidize the surface of the catalytic metal of the catalytic metal structure to produce the 3-D metal catalyst.

19. The method of claim 18, wherein the conditions of step (b) comprise heating the 3-D catalytically active metal structure in the presence of carbon dioxide, oxygen or water at 350° C. to 1000° C. or the conditions of step (b) comprise contacting the 3-D catalytically active metal structure or the oxidized 3-D catalytically active metal structure with elemental sulfur vapor, hydrogen sulfide, sulfur dioxide, dimethyl sulfoxide, carbon disulfide, or combinations thereof.

20. A method of producing carbon monoxide (CO) and sulfur dioxide (SO₂), the method comprising:
(a) obtaining a reaction mixture comprising carbon dioxide gas (CO₂(g)) and elemental sulfur; and
(b) contacting the reaction mixture with any one of the bulk three-dimensional (3-D) catalysts of claim 1 under conditions sufficient to produce a product stream comprising CO (g) and SO₂(g).
